(19) United States
(12) Patent Application Publication
(10) Pub. No.: US 2006/0239483 A1
(43) Pub. Date: Oct. 26, 2006

(54) Mounting frame for custom hearing aid instruments

(75) Inventors: Soren Falkesgaard Orts, Copenhagen SV (DK); Martin Bondo Jorgensen, Vaerlose (DK); Morten Bjorn Wagner, Virum (DK)

Correspondence Address: JENKENS & GILCHRIST, P.C., 225 WEST WASHINGTON, SUITE 2600, CHICAGO, IL, 60606, US

(73) Assignee: Sonion Roskilde A/S, Roskilde (DK)

(21) Appl. No.: 11/408,459

(22) Filed: Apr. 21, 2006

Related U.S. Application Data
(60) Provisional application No. 60/673,666, filed on Apr. 21, 2005.
(60) Provisional application No. 60/684,874, filed on May 26, 2005.

(51) Int. Cl. H04R 25/00

(52) U.S. Cl. 381/312

(57) ABSTRACT

A hearing aid is provided that includes a hollow customized shell adapted to an individual's ear canal. The shell has a frontal surface part having an opening to an interior of the hollow customized shell. The shell has an edge portion between the frontal surface part and a second surface part of the shell adapted for engagement with the individual's ear canal. An intermediary frame is fixedly positioned in the opening. A hearing aid module is adapted to be removably fixed in the intermediary frame.

### CROSS-REFERENCE TO RELATED APPLICATIONS

This application claims priority to, and hereby incorporates by reference, U.S. Provisional Application No. 60/673,666, entitled “Mounting Frame for Custom Hearing Aid Instruments,” filed Apr. 21, 2005, and U.S. Provisional Application No. 60/684,874, entitled “Mounting Frame for Custom Hearing Aid Instruments,” filed May 26, 2005, with the United States Patent and Trademark Office.

### FIELD OF THE INVENTION

The present invention relates to a mounting frame for custom hearing aids such as “In the Ear,” “In The Canal” or “Completely In the Canal” types. In particular, the invention relates to a novel manner of removably fixing a hearing aid module in a customized shell with a shape derived from a physical or scanned representation of a users' ear canal.

### BACKGROUND OF THE INVENTION

The “In the Ear,” “In The Canal” or “Completely In the Canal” types of hearing aids have typically been manufactured using manual labor to a very large extent. The molding of the customized hearing aid shell in itself has been difficult, as well as the placement and finishing of the face plate covering an upper opening of the hearing aid shell and pointing away from the person's ear canal when the hearing aid is positioned therein. This finishing operation has traditionally been performed manually by mounting and gluing the faceplate to the hearing aid shell and thereafter cutting, sawing and polishing that circumferential portion of the customized hearing aid where the customized shell and faceplate are joined.

The orientation and placement of the face plate is important for two reasons: 1) it defines a boundary of the inner space of the hearing aid in which there must be allocated space for individual hearing aid components such as amplifier, battery, receiver, microphone, etc.; 2) it constitutes an outer and visible part of the hearing aid and should preferably fit the user's ear snugly without protruding edges or portions in order to be comfortable to wear and inconspicuous.

However, these manual operations are relatively inefficient. In recent years, computer-assisted automatic manufacturing methods for production of the customized hearing aid shells have entered the hearing aid market in form of stereo lithography-based manufacturing methods such as stereo lithography (“SLA”) and stereo laser sintering (“SLS”). Stereo lithography manufacturing methods utilize a computer system that receives data from a computer-aided design (“CAD”) model of the hearing aid shell contour and cures a liquid photopolymer resin with a laser beam to form a solid three-dimensional shell conforming to the desired shell contour.

The rapid prototyping stereo lithography makes it possible to build customized shells with a relatively well-defined frontal opening for receipt of a hearing aid module.

It has, unfortunately, been found that dimensional imperfections of these stereo lithography-based methods for custom shell formation have made this otherwise attractive shell manufacturing method unsuitable for directly forming a frontal opening in the custom shell for receipt of a hearing aid module with predetermined dimensions. Individual features of the frontal opening and accompanying engagement means such as notches and protrusions are difficult or impractical to make with sufficient precision to allow a reliable and strong coupling to the corresponding engagement means of the hearing aid module. This lack of precision in small shell features of stereo lithography manufactured custom shells is particularly troublesome if it is desired to design the hearing aid module in a manner so it can be released from the custom shell after manufacturing. The releasable feature of the hearing aid module is attractive for many purposes such as, e.g., during service and repair where a technician needs to repair or replace electrical or electro-acoustical components arranged inside a custom shell of a hearing aid. The present invention is directed to satisfying this and other needs.

### SUMMARY OF THE INVENTION

According to one embodiment of the invention, a hearing aid is provided that includes a hollow customized shell adapted to an individual's ear canal. The shell has a frontal surface part having an opening to an interior of the hollow customized shell. The shell has an edge portion between the frontal surface part and a second surface part of the shell adapted for engagement with the individual's ear canal. An intermediary frame is fixedly positioned in the opening. A hearing aid module is adapted to be removably fixed in the intermediary frame.

According to another embodiment of the invention, an intermediary frame is provided for use in a customized hearing aid having a hollow customized shell adapted to an individual's ear canal. The intermediary frame has an outer surface having a predetermined outer dimension. The intermediary frame also includes an opening having at least one engagement element to allow removable engagement with a hearing aid module.

According to yet another embodiment of the invention, a plurality of hearing aids is provided. Each hearing aid has a hollow customized shell adapted to an individual's ear canal. The hollow customized shell has an opening at a frontal surface part adapted to point out of the individual's ear canal. When the shell is positioned in the individual's ear canal, the hollow customized shell has an edge portion between the frontal surface part and a second surface part of the hollow customized shell adapted to engage the ear canal. An intermediary frame is fixedly positioned in the opening. The intermediary frame of each of each hearing aid is substantially identical. A hearing aid module is adapted to receive an output sound. The hearing aid module is adapted to be removably fixed in the intermediary frame of the hearing aid.

According to still another embodiment of the invention, a method of manufacturing a customized hearing aid is provided. A hollow customized shell adapted to an individual's ear canal is prepared. The hollow customized shell has an opening to an interior of the hollow customized shell. An intermediary frame is fixedly positioned in the opening. A hearing aid module is coupled within the intermediary frame.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

In the following, preferred embodiments of the invention will be described with reference to the drawing, wherein:

FIG. 1 illustrates the overall elements of a hearing aid according to an embodiment of the invention;

FIG. 2 illustrates a preferred intermediate element for use in the hearing aid of FIG. 1;

FIG. 3 illustrates an alternative hearing aid module comprising further elements;

FIG. 4 illustrates one manner of fixing the intermediate element to a shell; and

FIG. 5 illustrates another manner of fixing the intermediate element to the shell.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

According to one embodiment of the invention, a hearing aid is provided that has a hollow customized shell adapted to an individual's ear canal. The shell has a frontal surface part comprising an opening to an interior of the hollow customized shell. The shell also has an edge portion between the frontal surface part and a second surface part of the shell adapted for engagement with the ear canal. The hearing aid includes an intermediary frame fixedly positioned in the opening. A hearing aid module is adapted to be removably fixed in the intermediary frame.

Naturally, the shell may be manufactured in any manner, but when the edge portion between the first and second surface parts is now a part thereof, a part of the manual labor may now be avoided, and the definition of the frontal part may be made fully electronic, if desired.

In one embodiment of the invention, the frontal surface part is the part visible to or engageable from outside the ear, when the hearing aid is positioned in the individual's ear canal. The fixed connection between the shell and the intermediary frame may be a permanent fixing using, e.g., an adhesive or welding/soldering. Alternatively, the fixing may be a click fixing where the intermediary frame is clicked into the shell opening.

The hearing aid module is normally provided as a single housing or as a number of operationally interconnected elements, one of which is attached in the opening of the shell. Preferably, the shell is a monolithic element, which may include a cured photo-polymer resin, such as if it was formed in a liquid photopolymer resin manufactured by stereo lithography techniques such as SLS or SLA.

Normally, the frontal surface part is at least substantially flat and the edge portion is rounded. This, however, is not a requirement to take advantage of an embodiment of the invention. A flat frontal surface part has been the simplest shape. A rounded or otherwise non-flat surface may be desirable in order to better suit the shape of the individual's ear canal.

Preferably, the hearing aid module and the intermediate frame have a mating engagement element/elements for releasable engagement. This facilitates removal of the hearing aid module from the custom hearing aid assembly for repair purposes or the like.

In addition, the hearing aid may further include an acoustically sealing member, such as a rubber sealing or a snug fit, between the shell and the frame. This sealing member is provided to prevent any acoustic feedback between the inner space of the shell and the surroundings.

In a second aspect, the invention relates to an intermediary frame for use in a customized hearing aid having a hollow customized shell adapted to an individual's ear canal. In this aspect, the frame has an outer surface with a predetermined outer dimension or shape. The frame also includes an opening having an engagement element/elements allowing removable engagement with a hearing aid module. This frame may be manufactured in any manner desired, such as by injection molding, metal stamping, or combinations thereof.

Preferably, the frame includes engaging parts adapted to engage corresponding parts of the hearing aid module in order to facilitate the releasable engagement. Such engaging parts may facilitate a clicking and/or a rotating movement or action between the two parts.

The frame may have outer dimensions adapted to engage a square opening having a length of 5-15 mm, such as 7-13 mm, preferably 9-11 mm, and a width of 2-9 mm, such as 4-7 mm, preferably 5-6 mm.

A third aspect of the invention relates to a hearing aid module assembly having a frame according to the second aspect of the invention and a hearing aid module. The hearing aid module and the frame have an element/elements for removable engagement between the hearing aid module and the frame. Again, the frame may include an acoustically sealing member positioned along the outer dimension or shape.

A fourth aspect of the invention relates to the advantages of the modular design in that it relates to a plurality of hearing aids. Each hearing air has a hollow customized shell adapted to an individual's ear canal. The shell has an opening at a frontal surface part adapted to point out of the person's ear canal. When the shell is positioned in the person's ear canal, the shell has an edge portion between the frontal surface part and a second surface part of the shell adapted to engage the ear canal. An intermediary frame is fixedly positioned in the opening. All intermediary frames of the plurality of hearing aids are substantially identical. A hearing aid module is adapted to receive an output sound. The hearing aid module is adapted to be removably fixed in the intermediary frame of the individual hearing aid.

Thus, the shells, which must each be adapted to a particular ear canal, are the only custom-made elements. The shells may have identical or near identical openings, whereby the intermediary frames and the hearing aid modules may be identical or at least have identical outer dimensions engaging the shell or each other. Naturally, a plurality of different hearing aid modules may be made having identical engaging means for engaging the same frame.

Any production or dimensional imperfections between the shell and the frame may be handled using a suitable sealing material or an adhesive such as a photo curable epoxy resin. This sealing material or sealing member may be provided between the shell and the frame of each hearing aid.

A final aspect of the invention relates to a method of manufacturing a hearing aid. A hollow customized shell adapted to an individual's ear canal is prepared. An intermediary frame is fixedly positioned in the opening. A hearing aid module is coupled within the intermediary frame.

As indicated above, the shell may be a monolithic element, such as one made by curing a photo curable resin to obtain a shape corresponding to that of the individual's ear canal, such as made by the SLA or SLS technique.

Preferably, the shell has a frontal surface part having an opening to an interior of the hollow customized shell. The shell also preferably has an edge portion between the frontal surface part and a second surface part of the shell adapted for engagement with the individual's ear canal.

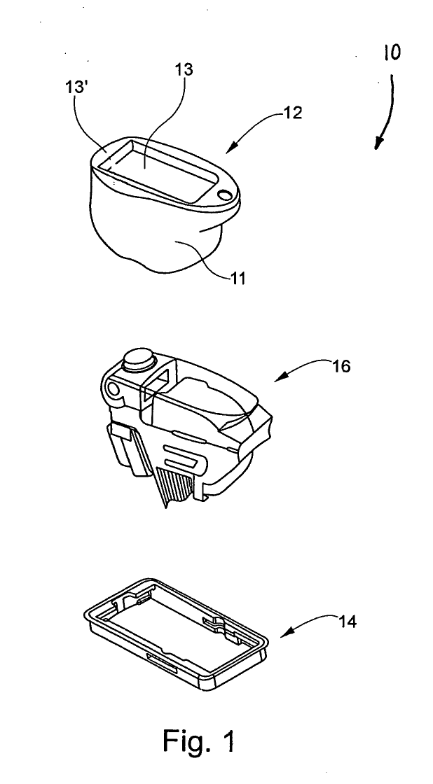

FIG. 1 illustrates a hearing aid 10 having a customized shell 12 for reception in the ear canal of a person. The shell 12 has an opening 13 at the part 13′ thereof pointing out of the ear canal of the individual wearing the hearing aid 10 when mounted.

In general, the shell 12 has the frontally facing part 13′ pointing outward from the person's ear canal when the shell is positioned therein. The part of the shell 12 actually engaging the user's ear canal is denoted 11, and the border between the part 11 and the part 13′ is prepared as an integral part of the shell. Consequently, no polishing or similar operations are required in that this part or edge may be prepared sufficiently smooth by the known stereo lithography (“SLA”) or stereo laser sintering (“SLS”) production methods.

This shell 12 is preferably prepared by stereo lithography techniques, such as SLA or SLS on the basis of an electromagnetic beam (laser or the like) scanning of the ear canal of the person or a model of the person's ear canal that may be obtained by traditional impression taking.

The intermediary frame 14 may be fixed in the opening 13 by any suitable means, such as adhesives, welding (laser welding, heat welding), soldering, or as a press fit. The intermediary frame 14 may be permanently or removably fixed in the opening 13.

Any dimensional slack between the intermediary frame 14 and the opening 13 may be filled during a welding, by adhesive or by a sealing member of any suitable type (foam, rubber or other resilient material or the like).

The hearing aid module 16 may be a standard hearing aid module, such as the module sold under the trade name Sonion® CU 10 hearing aid module. This hearing aid module 16 is adapted to be removably fixed in the intermediary frame 14 in order to facilitate replacement or repair thereof.

This fixing may be a click fixing or a combination of a clicking of a rod or axis into the intermediary frame 14 and a subsequent rotation and fixing of the hearing aid module 16 in the intermediary frame 14. This manner of fixing may be that normally used in the prior art when fixing a hearing aid module 16 to a shell.

The engaging or fixing organs of the frame 14 and the hearing aid module 16 are adapted to each other but may otherwise be chosen between all known alternatives: springs, snap locks, welding/de-welding, hook and loop fasteners, screws/nails/rivets, nut and bolt fasteners, adhesives, or the like. The preferred engaging organs are snap locks having disengaging organs (releasing the snap lock) engageable at the part 13′ or opening 13.

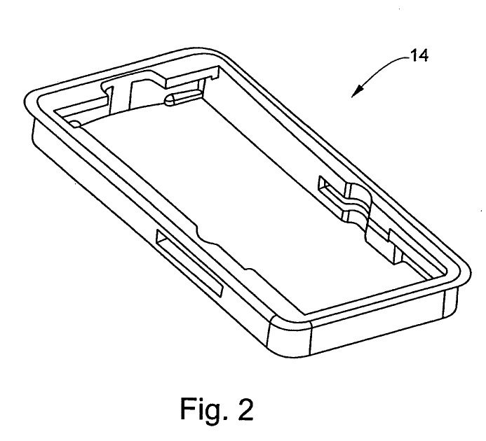

FIG. 2 illustrates a preferred intermediary frame 14, which has an inner surface adapted to receive a particular hearing aid module 16, which may be the above-mentioned Sonion® CU 10 hearing aid module or any other hearing aid module 16.

The outer dimensions and surface/shape may be standardized or may, however (in order to require the use of a certain type of hearing aid module) be especially adapted to a particular hearing aid module 16 or series of hearing aid modules 16. The outer dimensions/shape of the intermediary frame 14 may fit snugly in the opening 13 of a hearing aid shell, or there may be a slight slack for receiving a sealing member, adhesive or the like or for taking up any swelling or dimensional changes caused by other fixing methods such as soldering or welding.

The intermediary frame 14 may comprise or be constituted by a punched element made from a suitable metal such as stainless steel, but is preferably an injection molded frame from a plastic material, such as cellulose plastics, cellulose acetate (CA), cellulose acetate butyrate (CAB), cellulose acetate propionate (CAP), polyamides (PA), such as nylon, polyamides comprising carbon or nitrogen atoms, such as PA6 , PA11, PA12 or the like. Other suitable plastic materials are polyethylene (PE), such as high density PE (HDPE), medium density PE (MDPE), or low density PE (LDPE), polyethylene terephatalate (PET), acetate plastics and polyoxymethylene (POM).

The frame 14 may have outer dimensions adapted to engage a square opening having a length of 5-15 mm, such as 7-13 mm, preferably 9-11 mm, and a width of 2-9 mm, such as 4-7 mm, preferably 5-6 mm.

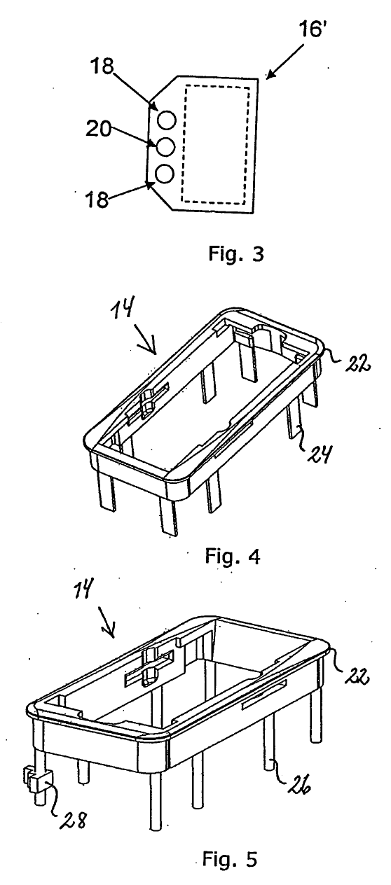

An alternative intermediary frame 14 for a hearing aid is illustrated in FIG. 3. The intermediary frame 14 may include all elements of the hearing aid 16 of FIG. 1, as well as additional elements such as two microphones 18 and a volume control button 20 also available at the outer surface of the hearing aid 16′. Naturally, this hearing aid 16′ requires another shape of the frame 14, but this is a simple adjustment.

The two microphones 18 of this hearing aid 16′ may be used as a directional microphone, and the volume control button 20 may be engageable by rotation and/or depression. Any other suitable controls or transducers may be provided at the outer surface of the hearing aid 16/16′ in order to obtain any desired function or operation.

FIG. 4 illustrates a particular manner of fixing the frame 14 in the opening of the shell 12 (see FIG. 1). The frame 14 has legs 24 that are flat and bendable to the sides once the frame 14 is positioned in the opening of the shell 12. This bending may be provided by operation via the opening in the frame 14 or by access via another opening in the shell 12. Alternatively, an element or elements in the shell 12 may be provided for performing the bending when the frame 14 is forced into or introduced into the opening of the shell 12.

FIG. 5 illustrates an alternative to the frame 14 of FIG. 4. In FIG. 5, the legs 26 are rounded instead of being flat. Naturally, these rounded legs 26 may be used and bent as described in relation to FIG. 4.

Alternatively, a locking element 28 may be provided on the legs 26. The locking element 28 may be rotatably and/or translatedly attached to the legs 26, so that these may be brought into a position in which they engage an inner surface of the shell 12 (see FIG. 1) subsequent to positioning the frame 14 in the opening of the shell 12. The locking element may maintain or bias the frame 14 in the position in the shell 12.

The locking element 28 and the legs 26 may comprise means for allowing movement of the locking element 28 only in a single direction (toward the frame 14) along the extent of the leg 26. Alternatively, the locking element 28 and the legs 26 may engage via a thread through which the locking element 28 may be biased against the inner surface of the shell 12.

The respective embodiments of the invention disclosed in FIGS. 4 and 5 include, as illustrated, a sealing member 22, which has the function of acoustically sealing the interior of the shell 12 from the exterior thereof This sealing member 22 may include a rubber element provided along the periphery of the frame 14, or an element of another resilient material. An alternative to this material is a thin, deformable lip part of the frame 14, where the lip part is adapted to engage and bias against the opening of the shell 12 in order to prevent sound transport from the interior to the exterior of the shell (or vice versa).

Another alternative to the sealing material may be the providing of an adhesive or the like which initially may be resilient of fluent and may take up any dimensional difference between the outer periphery of the frame 14 and the opening of the shell 12. This material may subsequently stiffen and form a solid sealing.

Each of these embodiments and obvious variations thereof is contemplated as falling within the spirit and scope of the claimed invention, which is set forth in the following claims.

What is claimed is:

1. A hearing aid comprising:
a hollow customized shell adapted to an individual's ear canal, the shell having a frontal surface part having an opening to an interior of the hollow customized shell, the shell having an edge portion between the frontal surface part and a second surface part of the shell adapted for engagement with the individual's ear canal,;
an intermediary frame fixedly positioned in the opening, and
a hearing aid module, the hearing aid module being adapted to be removably fixed in the intermediary frame.

2. The hearing aid according to claim 1, wherein the hollow customized shell is a monolithic element.

3. The hearing aid according to claim 1, wherein the hollow customized shell includes a cured photo polymer resin.

4. The hearing aid according to claim 1, wherein the frontal surface part is substantially flat and the edge portion is rounded.

5. The hearing aid according to claim 1, wherein the hearing aid module and the intermediary frame include at least one mating element for engagement.

6. The hearing aid according to claim 1, further including an acoustically sealing member between the hollow customized shell and the intermediary frame.

7. The hearing aid according to claim 1, further including a hearing aid module, wherein the hearing aid module and the intermediary frame have at least one element for removable engagement between the hearing aid module and the intermediary frame.

8. A hearing aid according to claim 7, further including an acoustically sealing member positioned along an outer dimension of the intermediary frame.

9. An intermediary frame for use in a customized hearing aid having a hollow customized shell adapted to an individual's ear canal, the intermediary frame comprising:
an outer surface having a predetermined outer dimension; and
an opening having at least one engagement element to allow removable engagement with a hearing aid module.

10. The frame according to claim 9, further including an acoustically sealing member positioned along the predetermined outer dimension.

11. A plurality of hearing aids, each hearing aid comprising:
a hollow customized shell adapted to an individual's ear canal, the hollow customized shell having an opening at a frontal surface part adapted to point out of the individual's ear canal, wherein when the shell is positioned in the individual's ear canal, the hollow customized shell has an edge portion between the frontal surface part and a second surface part of the hollow customized shell adapted to engage the ear canal;
an intermediary frame fixedly positioned in the opening, the intermediary frame of each hearing aid being substantially identical; and
a hearing aid module adapted to receive an output sound, the hearing aid module being adapted to be removably fixed in the intermediary frame of the hearing aid.

12. The plurality of hearing aids according to claim 11, wherein each hearing aid has an acoustically sealing member between the hollow customized shell and the intermediary frame.

13. A method of manufacturing a customized hearing aid, comprising
preparing a hollow customized shell adapted to an individual's ear canal, wherein the hollow customized shell has an opening to an interior of the hollow customized shell;
fixedly positioning an intermediary frame in the opening; and
coupling a hearing aid module within the intermediary frame.

14. The method according to claim 13, wherein the shell is a monolithic element.

15. The method according to claim 13, wherein the preparing of the hollow customized shell includes curing a photo curable resin to obtain a customized shape corresponding to a shape of the individual's ear canal.

16. The method according to claim 13, wherein the shell has a frontal surface part having the opening to the interior of the hollow customized shell, the shell having an edge portion between the frontal surface part and a second surface part of the shell adapted for engagement with the individual's ear canal.
